(19) United States
(12) Patent Application Publication
(10) Pub. No.: US 2004/0179971 A1
(43) Pub. Date: Sep. 16, 2004

(54) Method and device for transporting evacuated blood collection tubes

(75) Inventors: Margie M. Ferguson, East Orange, NJ (US); Megan M. Petersen, Palisades Park, NJ (US); Jeffrey Silvestri, Montclair, NJ (US)

Correspondence Address: Kirk M. Miles, Esq., WEBB ZIESENHEIM LOGSDON ORKIN & HANSON, P.C., 700 Koppers Building, 436 Seventh Avenue, Pittsburgh, PA, 15219-1818, US

(73) Assignee: Becton, Dickinson and Company

(21) Appl. No.: 10/387,096

(22) Filed: Mar. 12, 2003

(51) Int. Cl. B01L 3/00

(52) U.S. Cl. 422/99

(57) ABSTRACT

The present invention is directed to a retention mechanism for retaining a stopper on a test tube during pressure differentials, as well as a securing element for use therein. The retention mechanism includes a securing element for inhibiting strain between the stopper and the test tube. The present invention is also directed to a method of retaining a stopper on a test tube during pressure differentials. The method includes providing at least one adjustable retaining element and maintaining a force between a first portion and a second portion to maintain the stopper in fixed relation to the top end of the test tube.

### BACKGROUND OF THE INVENTION

1. Field of the Invention

The present invention relates to a retention mechanism for retaining a stopper on a test tube during pressure differentials.

2. Description of Related Art

Medical samples, such as blood, serum, urine, and other biological fluids are commonly transported daily to and from various locations all over the world. The distance and time constraints often dictate the mode of transportation. Air travel is a commonly used method for transporting biological fluids. Airplanes allow for transport of biological fluids in an expedient manner, as well as in bulk quantities. No matter what mode of transportation is utilized, the medical sample is only of value if maintained in a suitable condition. For example, specimens, as defined by the National Committee for Clinical Laboratory Standards, General Laboratory Practices & Safety, second edition, are “subject to the minimum packaging requirements of the PHS regulations and must withstand leakage of contents, shocks, pressure changes and other conditions incident to ordinary handling in transportation.” Therefore, the integrity of the specimen must be maintained.

A common problem that arises when transporting biological fluids in airplanes in containers, such as test tubes, is leakage of the fluids. This is most often caused by the pressure gradients or differentials that occur during air travel. For example, when transporting sealed test tubes at high altitudes, the pressure inside the sealed test tube is higher than the pressure outside the sealed test tube. As a result of this pressure gradient, the higher pressure in the sealed test tube may exert a force strong enough to cause the stopper on the sealed test tube to disengage from the test tube. This, in turn, leads to possible contamination of biological fluids, which results in high costs associated with replacing such fluids.

In view of the foregoing, a need exists for a retention mechanism that achieves effective retention of a stopper on a test tube during pressure differential occurrences during transport, and which is inexpensive to manufacture and simple to operate.

### SUMMARY OF THE INVENTION

The present invention is directed to a retention mechanism, as well as a method of retaining a stopper on a test tube during pressure differentials. The retention mechanism retains a stopper on a test tube during pressure differentials. The retention mechanism includes a securing element for inhibiting strain between the stopper and the test tube. The securing element extends between a first portion for accommodating an outer surface of the test tube and a second portion for accommodating an outer surface of the stopper. The first portion of the securing element includes a tube holder for receiving the outer surface of the test tube. The second portion of the securing element includes a cap member for receiving an outer surface of the stopper.

In one embodiment of the present invention, the securing element of the retention mechanism includes at least one adjustable strap maintaining the cap member spaced from the tube holder and capable of being fixed in a position for maintaining the stopper in fixed relation with the test tube. The adjustable strap of the securing element may be at least one elastomeric strap maintaining the cap member spaced from the tube holder and capable of exerting a pressure between the cap member and the tube holder. The retention mechanism can further include a plurality of elastomeric straps maintaining the cap member spaced from the tube holder.

In one particular embodiment, the retention mechanism includes a cap member, a tube holder, and a securing element. The cap member accommodates at least a portion of an outer surface of the stopper. The tube holder accommodates at least a portion of an outer portion of the test tube and the securing element extends between the cap member and the tube holder for inhibiting strain between the stopper and the test tube. The cap member and the tube holder may further include respective rigid tubular structures. At least one of the cap member or the tube holder may include a pressure release hole. The securing element may include at least one latch member adapted for adjustable fixed engagement between the cap member and the tube holder. For example, the first end of the at least one latch member may be pivotally attached to the tube holder. The cap member may be adjustably fixed to the at least one latch member at a second end opposing the first end.

In another embodiment, the securing element may include an elastomeric material capable of exerting a pressure between the cap member and the tube holder. Additionally, the securing element may further include an adjustable member capable of being fixed in a position maintaining the stopper in a fixed relation with the test tube.

In a further embodiment, the securing element may comprise a single member extending from opposing lateral sides of the tube holder and above the cap member. The cap member may have openings on opposing lateral sides thereof for accommodating the securing element therethrough. The retention member may further include a plurality of securing elements extending between and laterally spaced about the cap member and the tube holder.

In yet a further embodiment, the present invention is directed to a method of retaining a stopper on a test tube during pressure differentials. The method includes providing at least one adjustable retaining element. The retaining element includes a first portion adapted to accommodate a bottom or lower end of a test tube and a second portion adapted to accommodate a stopper, which is covering a top or upper end of the test tube. The method also includes maintaining a stopper in fixed relation to a top end of a test tube. The method further includes the step of providing a pair of adjustable retaining elements laterally spaced about the stopper and the test tube.

### BRIEF DESCRIPTION OF THE DRAWINGS

FIG. 1 is a perspective view of a retention mechanism in accordance with the present invention;

FIG. 2 is a perspective view of the retention mechanism of FIG. 1, shown in an engaged position;

FIG. 3 is a cross-sectional view of the retention mechanism of FIG. 2;

FIG. 4 is a perspective view of a multisample carrier in a disengaged position in an alternate embodiment of the present invention;

FIG. 5 is a perspective view of the multisample carrier of FIG. 4 in an engaged position;

FIG. 6 is a front view of the multisample carrier of FIG. 4 in an engaged position;

FIG. 7 is a perspective view of a retention mechanism in an alternate embodiment of the present invention;

FIG. 8 is a perspective view of the retention mechanism of FIG. 7 in an engaged position;

FIGS. 9-12 are perspective views of retention mechanisms in alternate embodiments of the present invention;

FIG. 13 is a perspective view of a retention mechanism in a further embodiment of the present invention shown in use retaining a test tube with a stopper;

FIG. 14 is a front view of the retention mechanism of FIG. 13;

FIG. 15 is a side view of the retention mechanism of FIG. 13;

FIG. 16 is a cross-sectional view taken along lines B-B of FIG. 15 with the retention mechanism shown in an engaged position;

FIG. 17 is a reverse cross-sectional view taken along lines B-B in FIG. 15 without a test tube and stopper contained therein; and

FIG. 18 is a perspective view of a retention mechanism in yet a further embodiment of the present invention.

### DETAILED DESCRIPTION

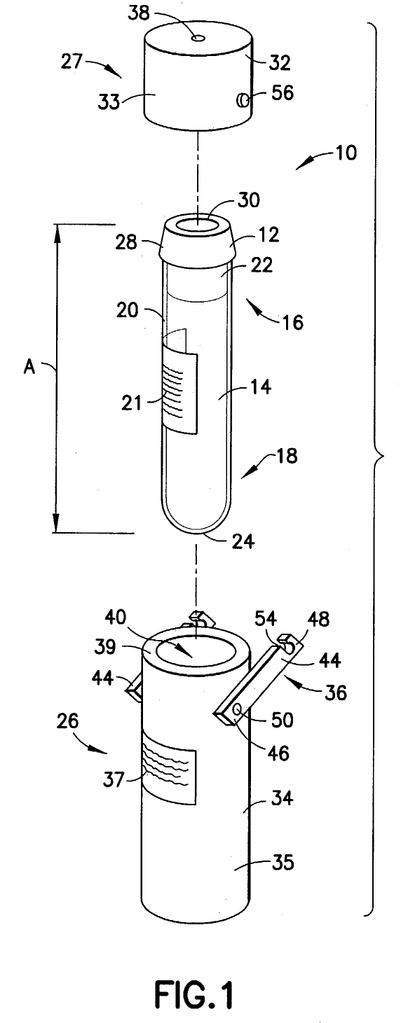

Referring to the drawings in which like reference characters refer to like parts throughout the several views thereof, FIGS. 1-3 illustrate a retention mechanism including a securing element in accordance with the present invention and the related features. While described in FIGS. 1-3 in terms of one embodiment of a retention mechanism, the securing element of the present invention may incorporate other embodiments.

As shown in FIGS. 1-3, a retention mechanism 10 retains a closure such as stopper 12 on a test tube 14 during occurrences of pressure gradients when transporting biological fluids in airplanes. Test tube 14 is an elongated cylindrical member having an upper end 16, a lower end 18 and an outer surface 20. The upper end 16 includes an opening 22, while the lower end 18 is closed by an integrally formed bottom 24. The interior of the test tube 14 may contain fluid, such as biological fluid. The opening 22 of upper end 16 of test tube 14 may be closed by the conventional stopper 12, which is made of a suitable elastomer, such as rubber. Stopper 12 has an outer surface 28 and a top surface 30 and fits snugly to close opening 22 of upper end 16 of test tube 14 in known manner. The outer surface 20 of test tube 14 may include a label 21, which may provide indicia to identify the contents of test tube 14.

It is contemplated that the closure on test tube 14 may be any type of closure known in the art for containing the contents of test tube 14 in a sealed environment. For example, the closure may be a combination type closure which includes a sealing stopper as well as a cap cover thereover for maintaining the stopper within the open end of the test tube. Such combination type closures are well known in the art, such as taught in U.S. Pat. No. 6,277,331 to Konrad.

Retention mechanism 10 is provided for containing test tube 14 with stopper 12 retained thereon. Retention mechanism 10 includes a first portion 26 which is provided for accommodating at least a portion of test tube 14 therein, and a second portion 27, which is provided for accommodating at least a portion of stopper 12 therein. At least one securing element 36 extends between the first portion 26 and the second portion 27, for maintaining the first and second portions 26, 27 in fixed longitudinal relation with respect to each other, as will be discussed in more detail herein.

First portion 26 is desirably provided as a tube holder 34. Tube holder 34 is of a generally cylindrical shape, including a tubular wall 39 defining an internal area 40 for accommodating test tube 14. Tubular wall 39 extends between a first closed end 41 and a second open end 43, which is open into internal area 40. Tube holder 34 accommodates outer surface 20 of test tube 14 within internal area 40 desirably covering a significant portion of the length of test tube 14. Tube holder 34 additionally supports test tube 14 during air transportation. First closed end 41 of tube holder 34 may be generally flat on the bottom surface thereof, thereby providing retention mechanism 10 as a freestanding mechanism. Tube holder 34 can be made of any type material, preferably one of a rigid tubular structure, such as plastic or the like. Tube holder 34 may further be provided with a label 37 having indicia thereon for identifying the contents thereof.

Second portion 27 is desirably provided as a cap member 32 for accommodating an outer surface 28 of stopper 12, so that stopper 12 fits securely into cap member 32. Cap member 32 may be any shape capable of accommodating the shape of stopper 12 such as a cylindrical shape as shown in FIGS. 1 including an interior area 31. Cap member 32 can be made of any type material, preferably one of a rigid tubular structure, such as plastic or the like. The rigid tubular structure provides additional protection around outer surface 28 of stopper 12, in addition to preventing movement between stopper 12 and test tube 14. A pressure release hole 38 may be located on top of cap member 32. Pressure release hole 38 is a hole through which pressure can escape, such as during assembly of retention mechanism 10 with test tube 14 and stopper 12 therein.

Securing element 36 extends between cap member 32 and tube holder 34. Securing element 36 is provided for maintaining cap member 32 and tube holder 34 in fixed relation therebetween, and may exert a slight pressure between stopper 12 and test tube 14. Securing element 36 is adjustable between an open and closed state, such that it is capable of being fixed in a position which maintains stopper 12 in fixed relation with test tube 14, and of being released so as to move cap member 32 away from a fixed relation with respect to tube holder 34 to access test tube 14 with stopper 12 retained thereon.

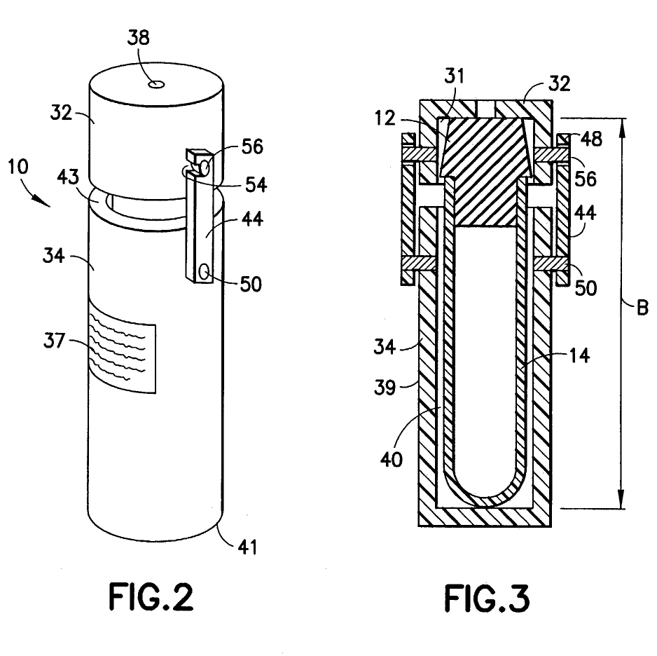

In a preferred embodiment of the present invention, securing element 36 includes at least one, and preferably two latch members 44, extending from opposing lateral sides of tube holder 34. Latch members 44 are independently adapted for adjustable fixed engagement between cap member 32 and tube holder 34, as illustrated in FIGS. 2-3. Each of latch members 44 has a first end 46 and an opposing second end 48 to provide engagement between cap member 32 and tube holder 34 and to prevent stopper 12 from disengaging during pressure changes. First end 46 of latch member 44 can be secured to outer surface 35 of tube holder 34 near the top of tube holder 34 by use of a connection means. Preferably, first end 46 of latch member 44 is pivotally attached to tube holder 34. Pivotal movement of each latch member 44 can be independently achieved through the use of a screw or hinge 50, or the like, extending from outer surface 35 of tube holder 34 and attaching each latch member 44 to tube holder 34. Each hinge 50 defines an axis for pivotal rotation of each latch member 44.

Second end 48 of each latch member 44 has an opening 54 to engage with a pair of corresponding lugs 56 extending outwardly from opposing lateral sides of cap member 32. Lugs 56 may be a screw or the like, which are desirably located near opposing lateral sides of the bottom of outer surface 33 of cap member 32.

Locking engagement between latch members 44 and lugs 56 provide for fixing cap member 32 relative to tube holder 34. In particular, to secure cap member 32 to tube holder 34, each of latch members 44 pivots around hinges 50 on tube holder 34 so that openings 54 of second ends 48 of latch members 44 engage with the corresponding lugs 56. The size of openings 54 of latch members 44 may be configured to as to provide a tactile and/or audible indication that latch members 44 have been properly engaged with or snap-fitted to lugs 56, thereby fixing cap member 32 relative to tube holder 34.

In use, test tube 14 including stopper 12 is placed within the internal area 40 of tube holder 34, with at least a portion of stopper 12 extending from open end 43 of tube holder 34. Cap member 32 is then placed over stopper 12, with at least a portion of stopper 12 contained within internal area 31. Latch members 44 are then pivotally rotated about the axis of hinges 50 to engage openings 54 with lugs 56. At this point, test tube 14 with stopper 12 attached thereto is contained within retention mechanism 10. At this point, the interior portion of retention mechanism 10 is defined by the combined internal area 31 of cap member 32 and internal area 40 of tube holder 34. The overall length A of test tube 14 with stopper 12 attached thereto is approximately the same as the overall length B of the interior portion of retention mechanism 10.

During transportation, and in particular air transportation, of test tube 14 contained within retention mechanism 10, a force may be exerted on stopper 12 due to high pressure inside test tube 14 and the low pressure outside test tube 14. By providing retention mechanism 10 with an interior portion having an overall length B that is substantially the same as the overall length A of test tube 14 with stopper 12, retention mechanism 10 prevents stopper 12 from disengaging from test tube 14 within the interior portion of retention mechanism 10. This is achieved through the strength of the engagement between tube holder 34 and cap member 32 as established through latch members 44 engaged with lugs 56. As such, the engagement force between latch members 44 and lugs 56 must be stronger than the pressure force exerted upon stopper 12 within test tube 14. As such, retention mechanism 10 exerts a force greater than or equal to the force experienced by stopper 12 during the given pressure gradients. This in turn, allows stopper 12 to remain engaged with test tube 14 during transport.

It is contemplated that the internal area 40 of tube holder 34 and/or the internal area 31 of cap member 32 may include a flexible material or a soft material such as a foam-like cushion lining at least a portion thereof, which provides a support surface for test tube 14 and/or stopper 12 during use. Such material, however, must be sufficiently rigid so as to be capable of maintaining the required amount of force applied against stopper 12 to prevent stopper 12 from disengaging from test tube 14 within the interior portion of retention mechanism 10. Retention mechanism 10 can be utilized more than one time for frequent use.

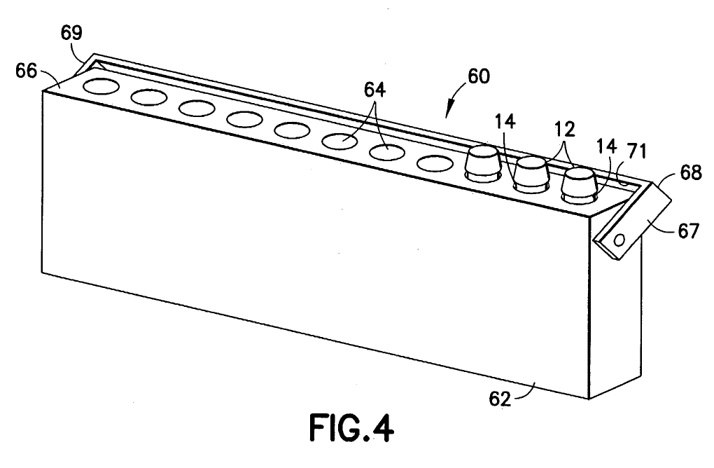

FIGS. 4-6 illustrate another embodiment of the present invention demonstrating a retention mechanism in the form of a multisample carrier 60. Multisample carrier 60 has a box-like structure 62 with a plurality of openings 64 along a top portion 66. Top portion 66 extends along the length of box-like structure 62. Openings 64 are generally cylindrical in nature to receive a plurality of containers such as test tubes 14 with biological fluids. A plurality of test tubes 14 are placed in openings 64 such that the outer surfaces 20 of test tubes 14 are protected by box-like structure 62 and the respective stoppers 12 project over top portion 66 of box-like structure 62.

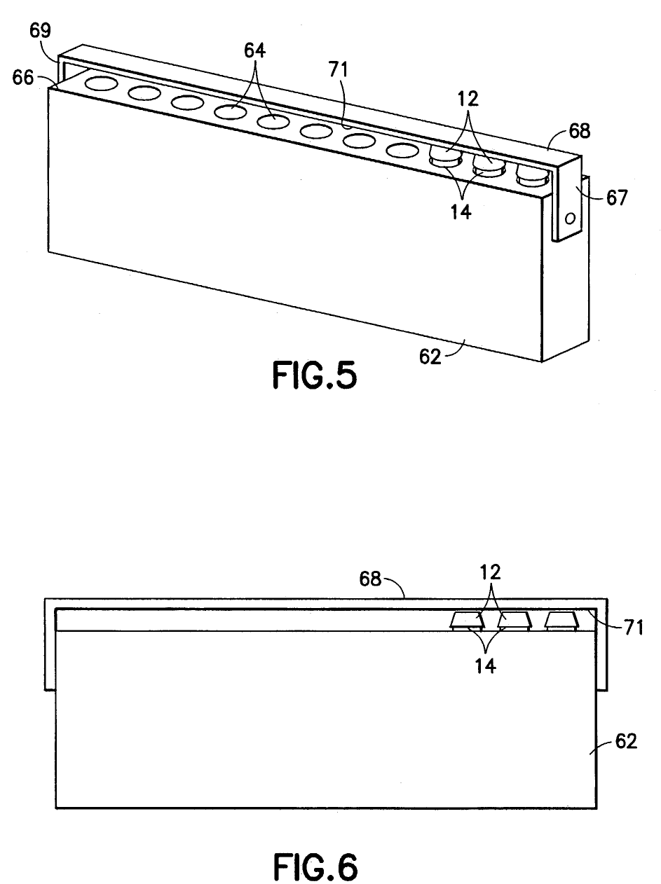

Multisample carrier 60, in addition to having box-like structure 62, has a handle 68 that is hingedly secured by any connection mechanism on opposing sides 67, 69 and extends along the length of top portion 66. When handle 68 is in a downright position, as illustrated in FIG. 4, top portion 66 of box-like structure 62 is accessible so as to place a plurality of test tubes 14 into openings 64. As illustrated in FIGS. 5-6, when handle 68 is in an upright position, handle 68 acts to retain stoppers 12 on test tubes 14 during pressure differentials when transporting fluids in airplanes. Desirably, inner surface 71 of handle 68 includes a foam-like flexible cushion. The foam-like cushion acts to absorb strain between stopper 12 and test tube 14.

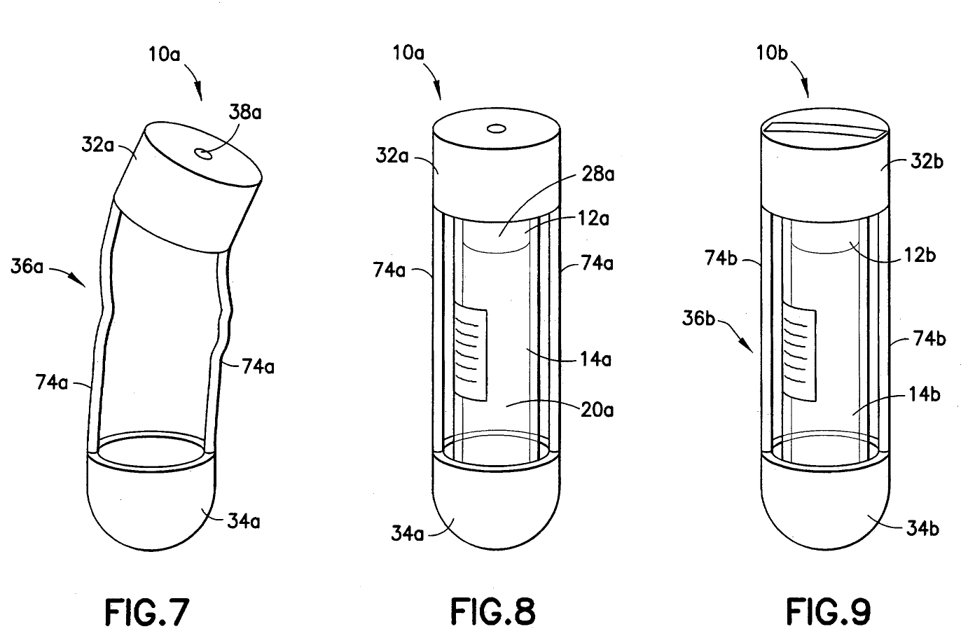

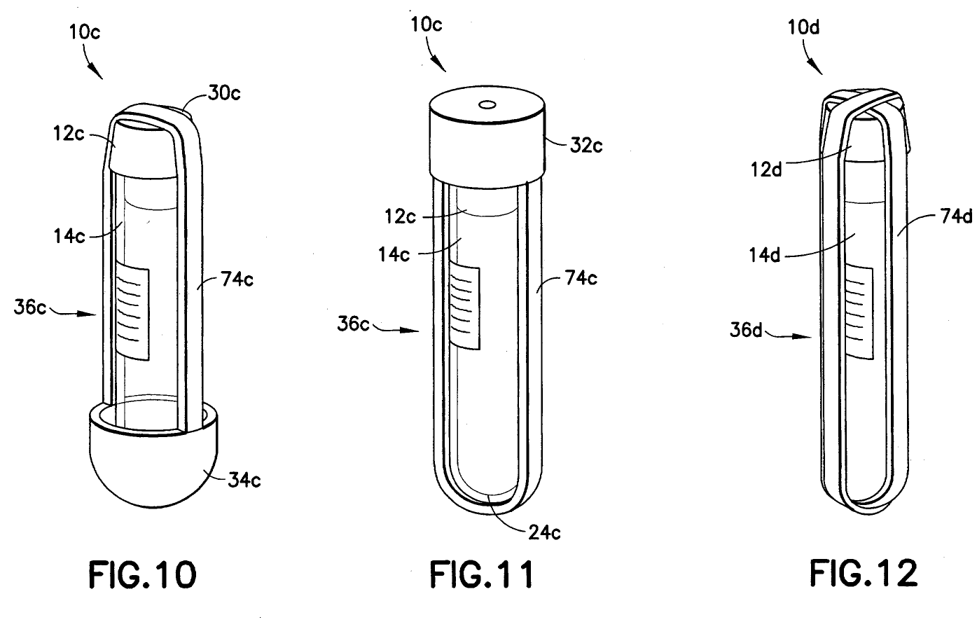

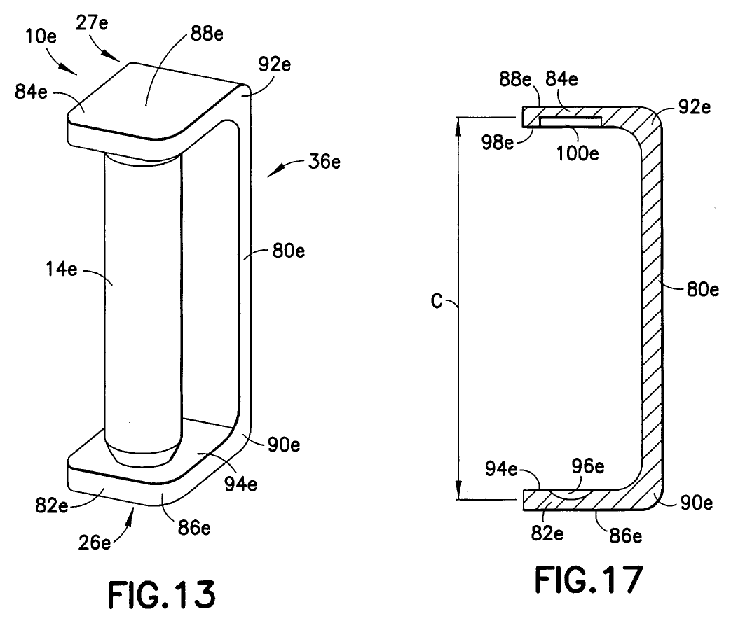

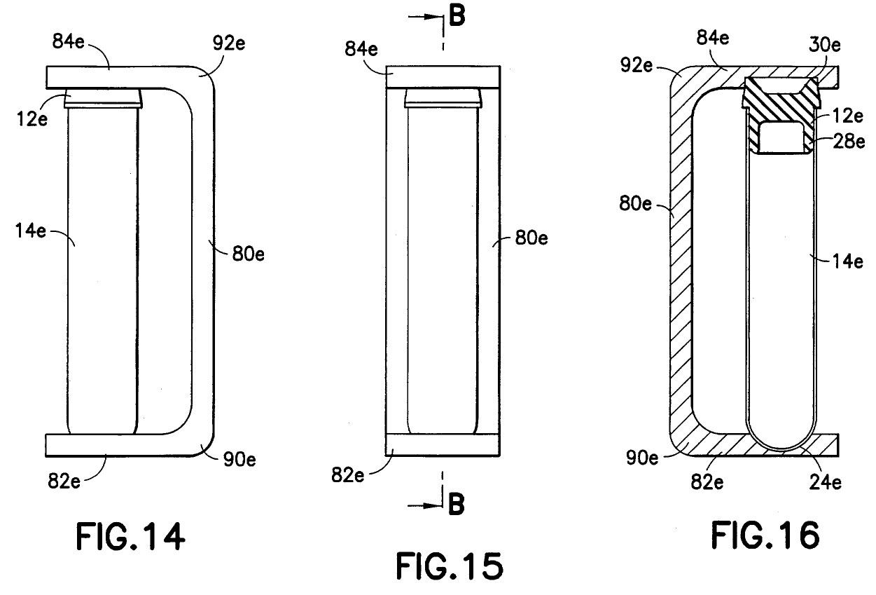

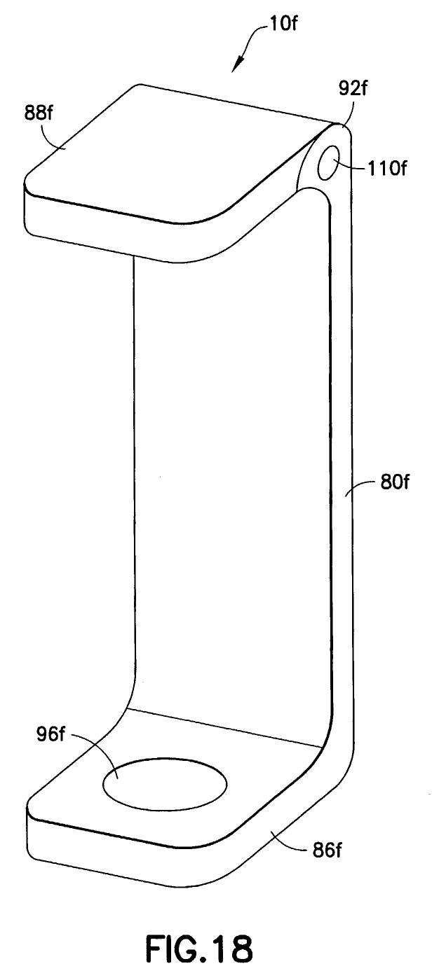

FIGS. 7-17 depict further embodiments of the invention that includes many components, which are substantially identical to the components of FIGS. 1-3. Accordingly, similar components performing similar functions will be numbered identical to those components of FIGS. 1-3 except that a suffix “a” will be used to identify those similar components in FIGS. 7-8; a suffix “b” will be used to identify those similar components in FIG. 9; a suffix “c” will be used to identify those similar components in FIGS. 10-11; a suffix “d” will be used to identify those similar components in FIG. 12; a suffix “e” will be used to identify those similar components in FIGS. 13-17; and a suffix “f” will be used to identify those similar components in FIG. 18.

As illustrated in FIGS. 7-8, retention mechanism 10a includes a securing element 36a extending between tube holder 34a and cap member 32a. Tube holder 34a accommodates a portion of outer surface 20a of test tube 14a, and is desirably shaped to include an inner profile which corresponds to the outer profile defined by the lower end of test tube 14a, such as a hemispherical shape. Cap member 32a accommodates outer surface 28a of stopper 12a. Tube holder 34a and cap member 32a are in spaced relation, with securing element 36a extending between tube holder 34a and cap member 32a. Securing element 36a is desirably a plurality of straps extending between tube holder 34a and cap member 32a, such as a pair of straps 74a. Straps 74a may be respectively attached to tube holder 34a and to cap member 32a. In particular, straps 74a may be affixed between tube holder 34a and cap member 32a through adhesive means, or may be integrally formed therewith to provide an integral structure. Straps 74a are provided to maintain tube holder 34a and cap member 32a at a fixed longitudinal position with respect to each other when test tube 14a with stopper 12a is inserted therebetween. As such, straps 74a prevent stopper 12a from disengaging from within test tube 14a.

Straps 74a are preferably constructed of an elastomeric material. As such, straps 74a can be extended so as to longitudinally displace tube holder 34a and cap member 32a such that test tube 14a with stopper 12a can be inserted therebetween. In addition, by providing straps 74a as an elastomeric material, straps 74a are capable of maintaining the cap member 32a spaced from the tube holder 34a and are capable of exerting a pressure between the cap member 32a and the tube holder 34a. Straps 74a must be sufficiently resilient such that the pressure exerted between the cap member 32a and the tube holder 34a is greater than or equal to the force experienced by stopper 12a during the given pressure gradients in order to cause stopper 12a to remain engaged with test tube 14a during transport. The resilient nature of elastomeric straps 74a absorbs the strain of the force of pressure on stopper 12a.

FIG. 9 illustrates another embodiment of the present invention, where retention mechanism 10b is similar to that illustrated in FIGS. 7-8. In the embodiment of FIG. 9, particular, securing element 36b is defined by a single strap 74b, which is attached to opposing sides of tube holder 34b and is connected to cap member 32b by being threaded through two small openings through cap member 32b.

Securing element 36b is secured by an adjustable strap 74b of a continuous piece. For example, adjustable strap 74b extends from tube holder 34b and across top of cap member 32b to provide secure engagement. Adjustable strap 74b is integrally formed with cap member 32b. For example, adjustable strap 32b can be threaded on the inside surface of cap member 74b.

FIGS. 10-11 illustrate further embodiments of the present invention, in which the retention mechanism includes either a cap member or a tube holder with a single securing element, preferably of an elastomeric material. In FIG. 10, retention mechanism 10c includes tube holder 34c and securing element 36c. Securing element 36c includes a single continuous strap 74c extending from opposing sides of tube holder 34c. Test tube 14c is placed in tube holder 34c and strap 74c extends over top surface 30c of stopper 12c to retain stopper 12c in fixed engagement with test tube 14c. The portion of strap 74c which surrounds stopper 12c is desirably configured so as to accommodate the shape of stopper 12c. During pressure gradients, stresses exerted by stopper 12c on retention mechanism 10c are absorbed by the flexible elastomeric material of securing element 36c so as to prevent disengagement of stopper 12c from test tube 14c.

FIG. 11 illustrates retention mechanism 10c with cap member 32c and a continuous securing element 36c in the form of strap 74c. Strap 74c extends from opposing sides of cap member 32c. In this embodiment, cap member 32c surrounds stopper 12c, and strap 74c extends around integrally formed bottom 24c of test tube 14c. The portion of strap 74c which surrounds bottom 24c of test tube 14c is desirably configured so as to accommodate the shape of test tube 14c.

FIG. 12 illustrates yet another embodiment of the present invention. Retention mechanism 10d includes a plurality of securing elements 36d. Securing element 36d, preferably of an elastomeric material, extends around stopper 12d and test tube 14d. Additional securing elements 36d are laterally spaced about stopper 12d and test tube 14d to provide secure engagement.

FIGS. 13-17 illustrate a further embodiment of the present invention. Retention mechanism 10e includes a securing element 36e with a first portion 26e and a second portion 27e. In the embodiment of FIGS. 13-17, securing element 36e includes a longitudinal member 80e extending between a bottom end 82e and a top end 84e. A first portion 26e is provided as a bottom extent 86e which extends laterally from bottom end 82e, forming a bottom flexible bend 90e therebetween. A second portion 27e is provided as a top extent 88e which extends laterally from top end 84e in a similar manner, forming top flexible bend 92e therbetween. Flexible bends 90e, 92e desirably extend at approximately a 90° bend, such that bottom extend 86e and top extent 88e extend in substantially a parallel plane with respect to each other. Desirably, retention mechanism 10e is a continuous, integral, one-piece unit extending between bottom extent 86e, longitudinal member 80e and top extent 88e. forming a generally C-shaped integral structure with the bottom extent and the top extent extending substantially parallel with respect to each other.

Bottom extent 86e forming first portion 26e is desirably in the form of a rectangular area platform with an inner surface 94e having recessed area 96e for receiving integrally formed bottom 24e of test tube 14e thereon. Recessed area 96e can be any shape capable of maintaining bottom 24e of test tube 14e therein, and desirably corresponds to the shape of integrally formed bottom 24e of test tube 14e, such as a hemispherical shape. Recessed area 96e aids in holding test tube 14e in place during transport.

Top extent 88e forming second portion 27e is also desirably rectangular in form, including an inner surface 98e having a recessed opening 100e therein. Recessed opening 100e is configured to receive a portion of outer surface 28e of stopper 12e so that stopper 12e fits securely into top extent 88e. Recessed opening 100e can be of any shape so long as recessed opening 100e accommodates the shape of top surface 30e of stopper 12e.

Retention mechanism 10e can be made of any type of material, and is desirably one of a rigid structure, such as plastic or the like. As noted, longitudinal member 80e extends between bottom extent 86e and top extent 88e, and is connected therebetween through flexible bends 90e, 92e. The pair of flexible bends 90e, 92e act as hinge-like portions which allow some flexing of bottom extent 86e and top extent 88e away from each other. This may be accomplished by providing flexible bends 90e, 92e as a separate material such as an elastomeric material, but is desirably accomplished through the flexible resiliency of the material forming retention mechanism 10e as a unitary integral piece. In this manner, flexible bends 90e, 92e can extend so as to displace bottom extent 86e and top extent 88e such that test tube 14e with stopper 12e can be inserted therebetween.

Moreover, the flexible bends 90e, 92e are sufficiently resilient such that inward pressure exerted between bottom extent 86e and top extent 88e is greater than or equal to the force experienced by stopper 12e during the given pressure gradients. This causes stopper 12e to remain engaged with test tube 14e during such pressure gradients, such as during air transport. The resilient nature of flexible bends 90e, 92e absorbs the strain of force of the pressure on stopper 12e. Additionally, recessed area 96e of inner surface 96e and/or recessed portion 100e of inner surface 98e may include a foam-like flexible cushion, which can act to absorb strain between stopper 12e and test tube 14e.

In use, integrally formed bottom 24e of test tube 14e including stopper 12e is placed within recessed area 96e of bottom extent 86e. Top extent 88e is then extended so that recessed opening 100e of top extent 88e fits snugly over the top surface 30e of stopper 12e. At this point, the interior portion of retention mechanism 10e is defined by the length C between recessed area 96e of bottom extent 86e and recessed opening 100e of top extent 88e. The overall length A of test tube 14e with stopper 12e attached thereto is approximately the same as the overall length C of the interior portion of retention mechanism 10e. As described hereinabove, by providing retention mechanism 10e with an interior portion having an overall length C that is substantially the same as the overall length A of test tube 14e with stopper 12e, retention mechanism 10e prevents stopper 12e from disengaging from test tube 14e within the interior portion of retention mechanism 10e.

FIG. 18 depicts a retention mechanism 10f which is similar to that disclosed in FIGS. 13-17, but further including a hinge 110f. More particularly, retention mechanism 10f includes longitudinal member 80f with bottom extent 86f extending laterally therefrom, and with top extent 88f extending laterally therefrom in a similar manner, forming top flexible bend 92f. Top flexible bend 92f includes hinge 110f for pivotally moving top extent 88f away from bottom extent 86f to access the interior space of retention mechanism 10f. In this manner, a test tube with a stopper can be inserted therein, and top extent 88f can be moved back into place to retain the test tube and stopper in place. Desirably, hinge 110f is a ratchet type hinge, and provides a locking position so as to provide sufficient force between top extent 88f and bottom extent 86f to retain a stopper on a test tube, as described hereinabove.

While the present invention is satisfied by embodiments in many different forms, there is shown in the drawings and, described herein in detail, the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing from the scope and spirit of the invention. The scope of the invention will be measured by the appended claims and their equivalents.

What is claimed is:

1. A retention mechanism for retaining a stopper on a test tube during pressure differentials, comprising:
a securing element for inhibiting strain between the stopper and the test tube, said securing element extending between a first portion for accommodating an outer surface of the test tube and a second portion for accommodating an outer surface of the stopper.

2. A retention mechanism as in claim 1, wherein the first portion of the securing element comprises a tube holder for receiving the outer surface of the test tube.

3. A retention mechanism as in claim 1, wherein the second portion of the securing element comprises a cap member for receiving an outer surface of the stopper.

4. A retention mechanism as in claim 1, wherein the first portion of the securing element comprises a tube holder for receiving the outer surface of the test tube and the second portion of the securing element comprises a cap member for receiving an outer surface of the stopper.

5. A retention mechanism as in claim 4, wherein the securing element comprises at least one adjustable strap maintaining the cap member spaced from the tube holder and capable of being fixed in a position maintaining the stopper in fixed relation with the test tube.

6. A retention mechanism as in claim 5, wherein the securing element comprises at least one elastomeric strap maintaining the cap member spaced from the tube holder and capable of exerting a pressure between the cap member and the tube holder.

7. A retention mechanism as in claim 6, further comprising a plurality of elastomeric straps maintaining the cap member spaced from the tube holder.

8. A retention mechanism as in claim 1, wherein the securing element comprises longitudinal member extending between a bottom extent having a recess for receiving the outer surface of the test tube and a top extent having a recess for receiving an outer surface of the stopper.

9. A retention mechanism as in claim 8, wherein the securing element forms a generally C-shaped integral structure, with the bottom extent and the top extent extending substantially parallel with respect to each other.

10. A retention mechanism as in claim 8, wherein one of the top extend or the bottom extent are connected to the longitudinal member through a hinge.

11. A retention mechanism for retaining a stopper on a test tube during pressure differentials, comprising:
a cap member for accommodating at least a portion of an outer surface of the stopper;
a tube holder for accommodating at least a portion of an outer surface of the test tube; and
a securing element extending between the cap member and the tube holder for inhibiting strain between the stopper and the test tube.

12. A retention mechanism as in claim 11, wherein the cap member and the tube holder comprise respective rigid tubular structures.

13. A retention mechanism as in claim 12, wherein at least one of the cap member or the tube holder includes a pressure release hole.

14. A retention mechanism as in claim 12, wherein the securing element comprises at least one latch member adapted for adjustable fixed engagement between the cap member and the tube holder.

15. A retention mechanism as in claim 14, wherein a first end of the at least one latch member is pivotally attached to the tube holder.

16. A retention mechanism as in claim 15, wherein the cap member is adjustably fixed to the at least one latch member at a second end opposing the first end.

17. A retention mechanism as in claim 16, further comprising a screw for fixing the cap member relative to the tube holder.

18. A retention mechanism as in claim 17, further comprising a screw for fixing the latching member relative to the tube holder to prevent pivotal rotation thereof.

19. A retention mechanism as in claim 11, wherein the securing element comprises an elastomeric material capable of exerting a pressure between the cap member and the tube holder.

20. A retention mechanism as in claim 11, wherein the securing element comprises an adjustable member capable of being fixed in a position maintaining the stopper in fixed relation with the test tube.

21. A retention mechanism as in claim 11, wherein the securing element comprises a single member extending from opposing lateral sides of the tube holder and about the cap member.

22. A retention mechanism as in claim 21, wherein the cap member includes openings on opposing lateral sides thereof for accommodating the securing element therethrough.

23. A retention mechanism as in claim 11, further comprising a plurality of securing elements extending between and laterally spaced about the cap member and the tube holder.

24. A method of retaining a stopper on a test tube during pressure differentials comprising providing at least one adjustable retaining element including a first portion adapted to accommodate a bottom end of the test tube and a second portion adapted to accommodate the stopper which is covering a top end of the test tube, and maintaining a force between the first portion and the second portion to maintain the stopper in fixed relation to the top end of the test tube.

25. A method as in claim 24, comprising providing a pair of said adjustable retaining elements laterally spaced about the stopper and test tube.

26. A retention mechanism for retaining a plurality of stoppers on a plurality of test tubes during pressure differentials comprising:
a carrier structure including a plurality of openings to receive the plurality of test tubes; and
a handle movably attached to the carrier structure, the handle being movable between an open position allowing access to the plurality of openings in the carrier structure, and an engaging position maintaining the plurality of test tubes with a plurality of stoppers thereon within the openings of the carrier structure, the handle contacting the plurality of stoppers when in the engaging position to maintain the plurality of stoppers in contacting relation on the plurality of test tubes.
